(19) United States
(12) Patent Application Publication
(10) Pub. No.: US 2025/0178066 A1
(43) Pub. Date: Jun. 5, 2025

(54) METHOD FOR PRODUCING ROLLING BEARING COMPONENTS WITH A HIGH DEGREE OF TOUGHNESS

(71) Applicant: Schaeffler Technologies AG & Co. KG, Herzogenaurach (DE)

(72) Inventors: Markus Dinkel, Würzburg (DE); Toni Blaß, Garstadt (DE); Werner Trojahn, Niederwerrn (DE); Andreas Bierlein, Haßfurt (DE)

(73) Assignee: Schaeffler Technologies AG & Co. KG, Herzogenaurach (DE)

(21) Appl. No.: 18/842,798

(22) PCT Filed: Dec. 6, 2022
(86) PCT No.: PCT/DE2022/100913

§ 371 Date: Aug. 30, 2024

(30) Foreign Application Priority Data
Mar. 3, 2022 (DE) 10 2022 104 982.5
Dec. 2, 2022 (DE) 10 2022 131 948.2

(51) Int. Cl. B21D 53/10

(52) U.S. Cl. CPC B21D 53/10

(57) ABSTRACT

A method for producing rolling bearing components with a high degree of toughness, includes: providing at least one rolling bearing component made of a steel material with a high degree of purity and having 0.70-1.1 wt. % of carbon and a mixture of alloy elements of more than 1.75 wt. % and less than 3.4 wt. % including manganese, chromium, and silicon. In a first method variant, the steps of austenizing, quenching, cooling, tempering, and subsequently cooling to room temperature are carried out, and a residual austenite content lying between 15 vol. % and 25 vol. % is produced in an obtained martensitic matrix. In a second method variant, the steps of austenizing, quenching, heating, and cooling to room temperature are carried out, and a residual austenite content lying between 2 vol. % and 18 vol. % is produced in an obtained bainitic matrix.

### CROSS-REFERENCE TO RELATED APPLICATIONS

This application is the United States National Phase of PCT Appln. No. PCT/DE2022/100913 filed Dec. 6, 2022, which claims priority to German Application Nos. DE102022104982.5 filed Mar. 3, 2022 and DE102022131948.2 filed Dec. 2, 2022, the entire disclosures of which are incorporated by reference herein.

### TECHNICAL FIELD

The present disclosure relates to a method for producing rolling bearing components with a high degree of toughness, e.g., for the production of rolling elements or rolling bearing rings.

### BACKGROUND

In the field of rolling bearings, such as ball bearings or spherical roller bearings, the requirements in terms of rolling strength and performance are constantly increasing. An increase in performance is relevant with regard to fatigue life and tolerance to contamination as well as adverse operating conditions.

According to the prior art, rolling bearings or rolling bearing components, such as rolling elements and rolling bearing rings, in particular inner bearing rings or outer bearing rings, are primarily produced from hypereutectoid rolling bearing steels in accordance with DIN EN ISO 683-17 (2015 edition). These are hardened either martensitically or bainitically to a hardness of more than 58 HRC.

Furthermore, it is known that higher loads occur in operation with a constant external load, particularly in the case of spherical roller bearings, than is the case with ball bearings. One reason for this is that, compared to ball bearings, spherical roller bearings have an increased amount of slip at the contact between the rolling element and the bearing ring, which makes spherical roller bearings more susceptible to surface-induced damage or pitting and fatigue damage.

The surface-induced damage or pitting limits the load capacity and the tool life, i.e., the service life of a rolling bearing and its rolling bearing components. In this regard, the higher the rolling contact pressure, the more likely it is that pitting will occur and the lower the so-called pitting resistance. In this context, running tests of rolling bearings have shown the rolling contact pressure that can be borne depending on the service life, i.e., on the number of rollovers until pitting occurs. This relationship is described by S-N curves or Wöhler curves of the pitting resistance for certain materials.

It is also known that contaminated lubricants as well as the lubricant film thickness and the surface condition of the rolling bearing components can reduce the service life of a rolling bearing, meaning that pitting can be expected to occur sooner. This is because contamination, surface condition and lubrication condition can negatively affect the contact between the rolling element and the rolling bearing ring. For example, a particle pressed into the raceway can lead to a change in the contact surface between the rolling element and the rolling bearing ring and thus to increased surface pressure. This can cause the surface of the rolling bearing ring to suffer pitting, which reduces the service life of the rolling bearing.

In this context, it is known to form rolling bearings from materials with high toughness, such as rolling bearing steels or rolling bearing steel alloys in accordance with DIN EN ISO 683-17 (2015 edition), which tend to be less susceptible to pitting and thus have a longer service life compared to rolling bearings made from other materials. But even with this, premature failures still occur.

### SUMMARY

The present disclosure provides a method for producing rolling bearing components with a high degree of toughness, which increases the load capacity, the tool life and thus the service life of a rolling bearing component and a rolling bearing, so that pitting can be avoided and the pitting resistance and the service life of a rolling bearing component or a rolling bearing formed therewith can be increased. The present disclosure also discloses a use of the method for producing rolling bearing components with a high degree of toughness of a rolling bearing.

A first aspect of the present disclosure includes a method for producing rolling bearing components with a high degree of toughness. This is because rolling bearing components with a high degree of toughness tend to be less susceptible to pitting and therefore have a high pitting resistance, so that the service life of a rolling bearing component, e.g., a rolling bearing or a spherical roller bearing, can be increased.

The method includes, as a first step, providing at least one rolling bearing component made of a steel material, wherein the steel material has a degree of purity such that in a microscopic examination of special steels for non-metallic inclusions in accordance with DIN 50602 (1998 edition) on average less than 100 non-metallic inclusions occur per 1000 mm2 of the polished surface. The steel material includes 0.70-1.1% by weight of carbon and a mixture of alloying elements of more than 1.75% by weight and less than 3.4% by weight, wherein the mixture of alloying elements includes manganese, chromium and silicon.

The subsequent step includes austenitizing, or the austenitization of, the at least one rolling bearing component in a temperature range such that austenite and carbides are present side by side in the microstructure of the steel material. Austenitizing can be carried out above the so-called austenitizing temperature Acl of the steel material of the at least one rolling bearing component. In addition, austenitizing can take place in a temperature range of 835° C. to 870° C. or in a temperature range of 845° C. to 860° C.

This is followed by a method step of quenching the at least one rolling bearing component in a targeted manner so that untransformed retained austenite is maintained. During quenching, the rolling bearing component is cooled to a temperature which is 10 to 20 Kelvin below a martensite start temperature of the steel material used, by transferring the rolling bearing component to a warm bath at a temperature in the range of 170 to 220° C. and holding it there for 14 to 25 min, whereby martensite is formed and untransformed retained austenite is maintained, and wherein carbon migrates from the formed martensite into the untransformed retained austenite.

The warm bath is, for example, a warm salt bath. The warm bath may have a temperature in the range of 190° C. to 210° C. Martensite is formed in the holding stage at a temperature in the range of 170° C. to 220° C., for example at a temperature in the range of 190° C. to 210° C. Here, the carbon is precipitated from the newly formed martensite in this holding stage and the carbon can partially migrate into a retained austenite that is still present. This further stabilizes it against transformation, as the supersaturation increases and thus the martensite start temperature of this retained austenite drops significantly. The carbon from the first martensite needles formed migrates into the retained austenite that is still present. A reduction in the carbon content has a positive effect on the toughness of the martensite. A further reduction of the matrix carbon cannot be achieved prior to the quenching process, for example by under-austenitizing the material in a targeted manner, as otherwise the workpieces cannot be through-hardened sufficiently.

An example steel material includes a carbon content of 0.70 to 1.05% by weight, e.g., of 0.80 to 1.05% by weight or 0.89 to 1.05% by weight, and a mixture of alloying elements of more than 1.75% by weight and less than 3.4% by weight, wherein the mixture of alloying elements includes manganese, chromium and silicon.

All temperatures and/or times stated depend on the rolling bearing component and batch size and the number of rolling bearing components as well as the batch structure. However, the average person skilled in the art can adjust these accordingly.

Following quenching, two alternatives are conceivable for the further course of the method.

### Alternative 1

As such, in a first alternative, the quenching is followed by a step of cooling the at least one rolling bearing component to room temperature.

After cooling, the step of tempering (so-called “partitioning”) the at least one rolling bearing component takes place in order to obtain a material structure with a martensitic matrix, possibly with fractions of bainite, and with a specified retained austenite content. Tempering is carried out by heating the rolling bearing component to a temperature in the range of 220 to 245° C. and holding it at this temperature for a period of 1 to 4 hours. A redistribution of the carbon in the course of tempering further reduces the resulting carbon in the martensite matrix, which in turn increases the toughness.

The steel material of the at least one rolling bearing component includes a martensitic matrix, optionally with fractions of bainite, and a retained austenite content in the range of 15% to 25% by volume.

Increased retained austenite contents meet higher requirements with regard to the tolerance of a rolling bearing when used in contaminated environmental conditions. By thermally stabilizing the component using the treatment described above, the retained austenite can be made exceptionally stable and can no longer be transformed—or only to a small extent—even at elevated application temperatures in the range of 150° C. to 180° C. or at increased surface pressures. This stable retained austenite provides a rolling bearing component with increased toughness in conjunction with a reduced carbon content in the martensite matrix.

Finally, a cooling to room temperature follows as the last step of the first alternative of the method.

As already mentioned, all temperatures and/or times stated depend on the rolling bearing component and batch size and the number of rolling bearing components as well as the batch structure. However, the average person skilled in the art can adjust these accordingly.

As explained above, two alternatives are conceivable for the further course of the method following quenching. While the first alternative has already been described above, the second alternative is described below.

### Alternative 2

In a second alternative, the quenching is followed by a step of heating the at least one rolling bearing component to a temperature above the martensite start temperature of the steel material used. For this purpose, the at least one rolling bearing component is transferred to a warm bath, e.g., a warm salt bath, at a temperature in the range of 220 to 240° C. and held there for a period of 3 to 24 hours in order to obtain a material structure with a bainitic matrix, e.g., containing carbides, and with a specified retained austenite content. Bainite is therefore formed and untransformed retained austenite is maintained. A redistribution of the carbon into the retained austenite during heating further reduces the resulting carbon content in the bainite matrix, which in turn increases the toughness.

The steel material of the at least one rolling bearing component is obtained with a bainitic matrix, e.g., containing carbides, and with a retained austenite content in the range of 2% to 18% by volume.

Increased retained austenite contents in rolling bearing components fulfill higher requirements with regard to the tolerance of a rolling bearing when used in contaminated environmental conditions. By thermally stabilizing the component using the treatment described above, the retained austenite can be made exceptionally stable and can no longer be transformed—or only to a small extent—even at elevated application temperatures in the range of 150° C. to 180° C. or at increased surface pressures. This stable retained austenite provides a rolling bearing component with increased toughness in conjunction with a reduced carbon content in the bainite matrix.

The holding period in the warm bath can depend on the rolling bearing component and batch size as well as the batch structure. However, the average person skilled in the art can adjust these accordingly.

After the warm bath, the at least one rolling bearing component is additionally transferred to a low-temperature oven or a further warm bath, such as a warm salt bath, in which the temperature is increasing or higher compared to the warm bath, e.g., at a temperature in the range of 220° C. to 280° C., until the specified retained austenite content is reached. Here, the holding period ranges from 0.5 to 10 hours.

Finally, a cooling to room temperature follows as the last step of the second alternative of the method.

All of the following features can apply to and be used for both the first alternative and the second alternative of the method.

As such, the steel material of the at least one rolling bearing component can comprise 0.7 to 1.05% by weight of carbon and a mixture of alloying elements of more than 3.05% by weight.

In addition, the steel material of the at least one rolling bearing component may include the following constituents:
0.7-1.05% by weight of carbon,
0.50-0.90% by weight or 0.40-0.75% by weight of silicon,
0.90-1.30% by weight or 0.80-1.70% by weight of manganese,
1.3-1.75% by weight or 0.90-2.05% by weight of chromium, and
residual iron and unavoidable trace elements or impurities (such as antimony (Sb), tin (Sn), arsenic (As) and the like).

Furthermore, the steel material of the at least one rolling bearing component can contain at most 0.10% by weight or at most 0.15% by weight or between 0.50% by weight and 0.6% by weight of molybdenum.

The above-mentioned elements within the described compositions of the steel material of the at least one rolling bearing component, when combined, cause an increase in the toughness of the at least one rolling bearing component. This is all the more true when using the method for producing rolling bearing components with a high degree of toughness. For example, the method steps of the first or second alternative of the method in combination with the aforementioned composition of the elements for a steel material of the at least one rolling bearing component result in a significant increase in the toughness of the steel material compared to the prior art. The increase in toughness leads to a higher pitting resistance or to a higher rolling strength and thus to an increase in the service life of the at least one rolling bearing component.

The steel material of the at least one rolling bearing component may include the following constituents:
max. 0.35% by weight of nickel,
max. 0.10% by weight of vanadium,
max. 0.060% by weight of aluminum,
max. 0.08% by weight of sulfur,
max. 0.025% by weight of phosphorus,
max. 0.003% by weight of titanium,
max. 0.015% by weight of nitrogen,
max. 0.007% by weight of oxygen,
max. 0.0035% by weight of calcium, and
max. 0.30% by weight of copper.

The maximum amount of the aforementioned elements within the composition of the steel material of the at least one rolling bearing component has little to no influence on the material properties and to such a small extent that these constituents are acceptable individually or in total within the aforementioned limits or in the aforementioned concentration. Furthermore, the steel material of the at least one rolling bearing component can contain a rolling bearing steel alloy.

The rolling bearing steel alloy can be selected from DIN EN ISO 683-17 (2015 edition) or from the older DIN 17230 (1980 edition).

The rolling bearing steel alloy may be the alloy with the designation 100CrMnSi4-4 or with the material designation 1.3518.

As an alternative to the aforementioned, the rolling bearing steel alloy can be the alloy with the designation 100CrMnSi6-6 or with the material designation 1.3519.

As a further alternative, the rolling bearing steel alloy can be the alloy with the designation 100CrMnSi6-4 or with the material designation 1.3520.

Further alternatively, the rolling bearing steel alloy can also be the alloy with the designation 100CrMnMoSi8-4-6 or with the material designation 1.3539.

The aforementioned rolling bearing steel alloys cause an increase in the toughness of the at least one rolling bearing component. This is all the more true when using the method for producing rolling bearing components with a high degree of toughness. For example, the method steps of the first or second alternative of the present invention in combination with the aforementioned rolling bearing steel alloys result in a significant increase in the toughness of the steel material compared to the prior art. The increase in toughness leads to a higher pitting resistance or to a higher rolling strength and thus to an increase in the service life of the at least one rolling bearing component, for example for the use of the aforementioned rolling bearing steel alloys in combination with the method steps of the first or second alternatives of the method for rolling bearings. e.g., spherical roller bearings.

In addition, a rolling bearing steel alloy according to DIN EN ISO 683-17 (2015 edition) can have fewer inclusions than required by DIN EN ISO 683-17 (2015 edition) in a microscopic examination of special steels for non-metallic inclusions. According to the disclosure, the steel material of the at least one rolling bearing component has a higher purity compared to DIN EN ISO 683-17 (2015 edition). The aforementioned rolling bearing steel alloy according to DIN EN ISO 683-17 (2015 edition) in combination with an increased purity or an increased degree of purity and in combination with the method steps of the first or second alternative of the method result in an increase in the toughness of the at least one rolling bearing component. The increase in toughness leads to a higher pitting resistance or to a higher rolling strength and thus to an increase in the service life of the at least one rolling bearing component, for example for the use of the aforementioned rolling bearing steel alloy according to DIN EN ISO 683-17 (2015 edition) in combination with the method steps of the first or second alternatives of the method for rolling bearings in the form of spherical roller bearings.

In a microscopic examination of special steels for non-metallic inclusions in accordance with DIN 50602 (1998 edition), the steel material of the at least one rolling bearing component exhibits less than 100 non-metallic inclusions per 1000 mm2 (square millimeters) of the polished surface or less than 0.1 non-metallic inclusions per 1 mm2 (square millimeter) of the polished surface, e.g., on average or averaged, in accordance with the disclosure. The steel material of the at least one rolling bearing component therefore has a high purity or high degree of purity, for example in comparison to the reference values of DIN EN ISO 683-17 (2015 edition).

The small number of non-metallic inclusions for the steel material of the at least one rolling bearing component in combination with the corresponding steel material of the at least one rolling bearing component and further in combination with the method steps of the first or second alternative of the method result in an increase in the toughness of the at least one rolling bearing component. The increase in toughness leads to a higher pitting resistance or to a higher rolling strength and thus to an increase in the service life of the at least one rolling bearing component, for example for the use of the steel material of the at least one rolling bearing component in combination with the method steps of the first or second alternatives of the method for rolling bearings, e.g., spherical roller bearings.

The steel material of the at least one rolling bearing component may have no type 4 inclusions or no inclusions with the size rating number 4 or greater of oxides (OA (“oxide inclusions of fragmented type”), OS (“oxide inclusions of elongated type”), OG (“oxide inclusions of globular type”)) and/or of sulfides (SS (“sulfide inclusions of elongated type”)). It does not matter in this regard whether the inclusion lines are thin or thicker or whether they are multiple lines relating to the inclusion types OA and OS, as described in DIN 50602 (1998 edition). The steel material of the at least one rolling bearing component therefore has a high purity or high degree of purity, for example in comparison to the reference values of DIN EN ISO 683-17 (2015 edition).

The avoidance of the above-mentioned type 4 inclusions or inclusions with the size rating number 4 or greater according to DIN 50602 (1998 edition) is also an indication of purity or the degree of purity. In this regard, the higher the degree of purity or the purity in connection with the steel material of the at least one rolling bearing component in combination with the corresponding steel material of the at least one rolling bearing component and furthermore in combination with the method steps of the first or second alternative of the method, the higher the toughness of the at least one rolling bearing component. The increase in toughness leads to a higher pitting resistance or to a higher rolling strength and thus to an increase in the service life of the at least one rolling bearing component, for example for the use of the steel material of the at least one rolling bearing component in combination with the method steps of the first or second alternatives of the method for rolling bearings in the form of spherical roller bearings.

For example, in the microscopic examination of special steels for non-metallic inclusions in accordance with DIN 50602 (1998 edition), the steel material of the at least one rolling bearing component has a total index, e.g., on average or averaged, of at most 100 per 1000 mm2 (square millimeters) of the polished surface or at most 0.1 non-metallic inclusions per 1 mm2 (square millimeter) of the polished surface with regard to type 1 inclusions of sulfides (SS) or with regard to inclusions of sulfides (SS) of size rating number 1 or smaller. The steel material of the at least one rolling bearing component therefore has a high purity or high degree of purity, for example in comparison to the reference values of DIN EN ISO 683-17 (2015 edition).

In the microscopic examination of special steels for non-metallic inclusions in accordance with DIN 50602 (1998 edition), the steel material of the at least one rolling bearing component may have a total index, e.g., on average or averaged, of at most 10 per 1000 mm2 (square millimeters) of the polished surface or at most 0.01 non-metallic inclusions per 1 mm2 (square millimeter) of the polished surface with regard to type 1 inclusions of oxides (OA (“oxide inclusions of fragmented type”), OS (“oxide inclusions of elongated type”), OG (“oxide inclusions of globular type”)) or with regard to inclusions of oxides (OA (“oxide inclusions of fragmented type”), OS (“oxide inclusions of elongated type”), OG (“oxide inclusions of globular type”)) of size rating number 1 or smaller. The steel material of the at least one rolling bearing component therefore has a high purity or high degree of purity, for example in comparison to the reference values of DIN EN ISO 683-17 (2015 edition).

With regard to the above-mentioned small numbers of non-metallic inclusions for the steel material of the at least one rolling bearing component in combination with the corresponding steel material of the at least one rolling bearing component and further in combination with the method steps of the first or second alternative of the method, an increase in the toughness of the at least one rolling bearing component is achieved. The increase in toughness leads-as already described several times-to a higher resistance or to a higher rolling strength and thus to an increase in the service life of the at least one rolling bearing component, for example for the use of the steel material of the at least one rolling bearing component in combination with the method steps of the first or second alternatives of the method for rolling bearings, e.g., spherical roller bearings.

Furthermore, the steel material of the at least one rolling bearing component can be obtained by a melting process or by remelting or by smelting.

The smelting or remelting or the melting process can include conventional air smelting, vacuum treatment in secondary metallurgy and/or vacuum smelting so that a steel with a high degree of purity or high purity can be produced.

Additionally or alternatively, the steel material of the at least one rolling bearing component can be obtained by a remelting process under inert gas or under a vacuum so that a steel with a high degree of purity or high purity can be produced.

The at least one rolling bearing component can be a rolling element or a rolling bearing ring, e.g., in the form of an inner and/or outer bearing ring.

The at least one rolling bearing component can also be at least a part of a ball bearing and/or a roller bearing and/or a spherical roller bearing and/or a transmission bearing and/or a wheelset bearing for railroad applications and/or a bolt for cam follower applications on which rolling elements roll. The at least one rolling bearing component according to the method presented can generally be used in industry and/or in the automotive sector.

In addition, the at least one rolling bearing component can be a stationary component or housing component or a rotating component or a shaft on which rolling elements roll.

A second aspect of the present invention includes a use of the method for producing rolling bearing components with a high degree of toughness, namely a use for producing rolling elements and/or rolling bearing rings. Furthermore, the method can be used for the production of shafts, bolts or housing components on which rolling elements roll, for the production of transmission bearings and/or for the production of wheelset bearings for railroad applications and/or of bolts for cam follower applications.

It is expressly pointed out that the features of the method for producing rolling bearing components with a high degree of toughness can be used individually or in combination with one another.

In other words, the features relating to the method can also be combined here with other features.

The method for producing rolling bearing components with a high degree of toughness can be used for the production of rolling elements and/or rolling bearing rings, e.g., inner and/or outer bearing rings, and/or for the production of shafts or housing components on which rolling elements roll, and/or for the production of transmission bearings and/or for the production of wheelset bearings for railroad applications and/or for the production of bolts for cam follower applications on which rolling elements roll.

In this regard, the rolling bearing components can be components of a ball bearing, a roller bearing and/or a spherical roller bearing.

It is expressly pointed out that the features of the method for producing rolling bearing components with a high degree of toughness can be used individually or in combination with one another.

In other words, the features relating to the method for producing rolling bearing components with a high degree of toughness can also be combined here with other features.

Thus, a rolling bearing component of a rolling bearing according to the disclosure is produced by the method according to the disclosure.

Rolling bearing components can be rolling elements and/or rolling bearing rings, e.g., inner and/or outer bearing rings.

Specifically, the rolling bearing component can be a part of a ball bearing and/or a roller bearing and/or a spherical roller bearing.

In the following, the disclosure described above is expressed again and in other words in a supplementary manner.

The present disclosure concerns increasing the load capacity, tool life or service life of rolling bearings as a necessary further development with regard to improving the sustainability of such machine elements.

In order to meet higher requirements with regard to the tolerance of a rolling bearing when used in contaminated environmental conditions, increased retained austenite contents are considered beneficial. Furthermore, a thermomechanically stable microstructure is regarded as a necessary condition for rolling strength, since residual austenite degradation due to operation can be regarded as part of the rolling fatigue process.

In addition, a good microscopic and macroscopic degree of purity may be necessary in order to attain long tool life of rolling bearings, as this constitutes the basis of the rolling strength. With regard to spherical roller bearings in particular, it can be noted that all factors can occur simultaneously, as increased amounts of slip during operation can lead to an increased temperature in the contact and the stress close to the edge can result in a pronounced sensitivity to inclusions close to the surface.

An increase in the performance of a rolling bearing component, such as that of a spherical roller bearing, can be achieved by heat treatment if the basis is a sufficiently good steel purity that does not cause premature inclusion-related failure.

Fundamentally, the present disclosure can be seen in a combination of a heat treatment and an exceptionally high microscopic degree of purity in a region close to the raceway at the level of remelted steel grades and in a combination for certain compositions of a steel material.

For this purpose, conventional air smelting can be used in conjunction with high degrees of forming and a new type of heat treatment that has not yet been used in this way in the field of rolling bearings.

A steel material with the following composition has proven itself for a method for producing rolling bearing components with a high degree of toughness:
0.7-1.05% by weight of carbon,
0.50-0.9% by weight of silicon,
0.9-1.3% by weight of manganese,
1.3-1.75% by weight of chromium,
max. 0.35% by weight of nickel,
max. 0.15% by weight of molybdenum,
max. 0.1% by weight of vanadium,
max. 0.060% by weight of aluminum,
max. 0.08% by weight of sulfur,
max. 0.025% by weight of phosphorus,
max. 0.003% by weight of titanium,
max. 0.015% by weight of nitrogen,
max. 0.007% by weight of oxygen,
max. 0.0035% by weight of calcium,
max. 0.30% by weight of copper, and
residual iron and unavoidable trace elements or impurities, such as antimony (Sb), tin (Sn), arsenic (As) and the like.

In this regard, the sum of manganese, chromium and silicon can be greater than

2.95% by weight, e.g., more than 3.05% by weight.

The steel material can also have a microscopic purity with an average inclusion density of 0.1 inclusions/mm2 (square millimeter) of the polished surface in relation to monovalent sulfides and 0.01 inclusions/mm2 (square millimeter) of the polished surface in relation to monovalent oxides. In any case, tetravalent inclusions (oxides and sulfides) should be avoided (see DIN 50602 (1998 edition)).

In addition, a high degree of purity can be achieved by conventional air smelting, vacuum treatment in secondary metallurgy or vacuum smelting and/or remelting processes under inert gas or a vacuum for maximum rolling strengths or for maximum Stribeck rolling contact pressure or for maximum pitting resistance. The microstructural stabilization of the steel material can be achieved by using an adapted austenitization in conjunction with a targeted heat treatment plus subsequent bainitization or martensitic hardening.

A low austenitizing temperature, e.g., a temperature range of 835° C. to 870° C. or in a temperature range of 845° C. to 860° C., can result in a reduced carbon content in the matrix well below the nominal 1% by weight of carbon, e.g., in the case of the steel material 100CrMnSi6-4. This has a positive effect on the basic toughness of the matrix. Of course, other steel materials or steel alloys as described above can also be used.

A redistribution of the carbon in the course of the heat treatment can further reduce the resulting carbon in the martensite or bainite matrix, which in turn can increase the toughness.

In the holding stage according to the alternative 1 in the range of 170° C. to 220° C., carbon is precipitated from the newly formed martensite and the carbon partially migrates into the retained austenite that is still present. This further stabilizes it against transformation, as the supersaturation increases and thus the martensite start temperature of this retained austenite drops significantly. The carbon from the first martensite needles formed migrates into the retained austenite that is still present. A reduction in the carbon can have a positive effect on the toughness of the martensite.

A further reduction of the matrix carbon cannot be achieved prior to the quenching process, e.g., by under-austenitizing the material in a targeted manner, as otherwise the workpieces cannot be through-hardened sufficiently.

In the martensitic embodiment, i.e., the first alternative, the workpiece has a martensitic matrix, possibly with fractions of bainite, and a retained austenite content of 15% to 25% by volume. By thermally stabilizing the component using heat treatment, this retained austenite can be made exceptionally stable and can no longer be transformed—or only to a small extent—even at elevated application temperatures in the range of 150° C. to 180° C. or at increased surface pressures. This stable retained austenite provides the component with increased toughness in conjunction with the reduced carbon content in the martensite matrix.

In the bainitic embodiment, i.e., the second alternative, the rolling bearing component has a bainitic matrix, in particular comprising carbides, and a remaining retained austenite according to the desired degree of transformation. This is in the range of 2% to 18% by volume.

The material properties achieved in this way are advantageous for use in rolling bearings, which in spherical roller bearings, for example, inherently exhibit a higher amount of slip, i.e., no clean rolling of the contact partners, and often experience mixed friction states due to the operating conditions.

The latter can cause higher friction in the contact surface, resulting in higher tangential stresses that increase the material load on the surface of the rolling bearing component. In addition, the inherent slip load can further increase the risk of surface-induced damage. By using the disclosed method for producing rolling bearing components with a high degree of toughness, the material resilience can be increased and the service life of a rolling bearing component can be improved compared to the prior art, as the increased toughness counteracts the onset of damage to the rolling bearing component.

By reducing the number of non-metallic inclusions, the risk of damage can also be reduced due to their effect as a damage starting point. In general, toughness-optimized material properties can be helpful with respect to tolerance against surface-induced damage. This also applies in the case of contamination of rolling bearings, as the increased toughness effectively enables the necessary adaptive deformation in the contact gap when rolling over foreign material, both via the retained austenite and through the carbon-reduced martensite or bainite matrix, without leading to rapid crack formation.

### DETAILED DESCRIPTION

The disclosure is explained in more detail below with reference to an exemplary embodiment.

A method for producing rolling bearing components with a high degree of toughness includes as a first step the provision of a rolling bearing component made of a suitable steel material, which is austenitized in a following step.

Austenitizing or the austenitization takes place in a temperature range such that austenite and carbides are present side by side. The austenitizing is carried out above the austenitizing temperature Acl of the steel material of the rolling bearing component. This takes place, for example, in a temperature range of 845° C. to 860° C.

The rolling bearing component is then quenched in a targeted manner so that untransformed retained austenite is maintained. This involves cooling to a temperature of 10 to 20 K below the martensite start temperature of the steel material used.

Specifically, the rolling bearing component is transferred to a warm salt bath with a temperature in the range of 190° C. to 210° C. The rolling bearing component remains in the warm bath for 14 to 25 minutes.

The first alternative for producing rolling bearing components with a high degree of toughness is described below, which follows after the quenching process.

In the first alternative, the quenching is followed by a step of cooling the rolling bearing component to room temperature.

After cooling, the step of tempering the rolling bearing component takes place in order to obtain a material structure with a martensitic matrix (possibly with fractions of bainite) and with a specified retained austenite content. In this regard, tempering is carried out below the austenitizing temperature Acl of the steel material of the rolling bearing component at a temperature in the range of 220 to 240° C. over a period of 1 to 4 hours.

The retained austenite content obtained is in the range of 15% and 25% by

volume.

The tempering time depends on the rolling bearing component and batch size, as well as on the batch structure if multiple rolling bearing components are treated at the same time.

Then, or finally, the rolling bearing component is cooled to room temperature.

The second alternative for producing rolling bearing components with a high degree of toughness is described below, which, like the first alternative, follows the quenching process described above.

As such, in the second alternative after quenching, the rolling bearing component is heated in a further step to a temperature above the martensite start temperature of the steel material used. For this purpose, the rolling bearing component is transferred to a warm salt bath in order to obtain a material structure with a bainitic matrix (with carbides) and with a specified retained austenite content.

Heating is carried out in such a way that the specified retained austenite content is in the range of 2% to 18% by volume.

In order to achieve this, the warm salt bath has a temperature in the range of 220° C. to 240° C. Furthermore, the rolling bearing component is left in the warm salt bath for a holding period of 6 to 24 hours in order to obtain the specified retained austenite content. The holding period depends on the rolling bearing component and batch size as well as on the batch structure if multiple rolling bearing components are treated at the same time.

After the holding period in the warm bath, the rolling bearing component is transferred to a low-temperature oven, in which the temperature is increasing or higher compared to the warm salt bath, with a temperature in the range of 220° C. to 280° C. and held there for a period of 0.5 to 10 hours until the specified retained austenite content is reached.

Then, or finally, the rolling bearing component is cooled to room temperature.

All of the following explanations apply to the first alternative and second alternative of the present disclosure.

The steel material of the rolling bearing component may include 0.7-1.05% by weight of carbon and a mixture of alloying elements of more than 3.05% by weight, and the mixture of alloying elements includes manganese, chromium and silicon.

For example, the steel material of the rolling bearing component has the following constituents:
0.7-1.05% by weight of carbon,
0.50-0.90% by weight of silicon,
0.90-1.30% by weight of manganese.
1.3-1.75% by weight of chromium, and
residual iron and unavoidable trace elements or impurities (such as Sb, Sn, As and the like).
the steel material of the rolling bearing component may include the following constituents:
max. 0.35% by weight of nickel,
max. 0.10% by weight of vanadium,
max. 0.060% by weight of aluminum,
max. 0.08% by weight of sulfur,
max. 0.025% by weight of phosphorus,
max. 0.003% by weight of titanium,
max. 0.015% by weight of nitrogen,
max. 0.007% by weight of oxygen,
max. 0.0035% by weight of calcium, and
max. 0.30% by weight of copper.

The maximum amount of the aforementioned elements within the composition of the steel material of the rolling bearing component has little to no influence on the material properties and to such a small extent that these constituents are acceptable individually or in total within the aforementioned limits or in the aforementioned concentration.

More specifically, the steel material of the rolling bearing component includes a rolling bearing steel alloy selected from DIN EN ISO 683-17 (2015 edition) (formerly DIN 17230 (1980 edition)).

For example, this is the rolling bearing steel alloy with the designation 100CrMnSi6-4 or with the material designation 1.3520.

Furthermore, the rolling bearing steel alloy according to DIN EN ISO 683-17 (2015 edition) has fewer inclusions than required by DIN EN ISO 683-17 (2015 edition) in a microscopic examination of special steels for non-metallic inclusions.

In other words, in a microscopic examination of special steels for non-metallic inclusions in accordance with DIN 50602 (1998 edition), the steel material of the rolling bearing component, on average or averaged, has less than 100 non-metallic inclusions per 1000 mm2 (square millimeters) of the polished surface.

In addition, the steel material of the rolling bearing component has no type 4 inclusions of oxides (OA, OS, OG) and sulfides (SS).

More specifically, in the microscopic examination of special steels for non-metallic inclusions in accordance with DIN 50602 (1998 edition), the steel material of the rolling bearing component has a total index, on average or averaged, of at most 100 per 1000 mm2 (square millimeters) of the polished surface with regard to type 1 inclusions of sulfides (SS).

Furthermore, in the microscopic examination of special steels for non-metallic inclusions in accordance with DIN 50602 (1998 edition), the steel material of the rolling bearing component has a total index, on average or averaged, of at most 10 per 1000 mm2 (square millimeters) of the polished surface with regard to type 1 inclusions of oxides (OA, OS, OG).

In order to obtain this low number of inclusions and to obtain an increased degree of purity or an increased purity, the steel material of the rolling bearing component is obtained by a melting process or by remelting or by smelting.

The melting or remelting or smelting process is carried out using vacuum smelting, so that a steel with a high degree of purity or high purity can be produced. Alternatively, it is also possible for the steel material of the rolling bearing component to be obtained by a remelting process under inert gas or a vacuum.

Generally speaking, it should be noted that the rolling bearing component may be a rolling element and/or a rolling bearing ring, e.g., an inner and/or an outer bearing ring. In this regard, the rolling bearing component is, for example, a component of a spherical roller bearing.

However, it is also possible that the rolling bearing component is at least a part of a transmission bearing or a wheelset bearing for railroad applications and/or a bolt for cam follower applications.

In other words, the method presented for producing rolling bearing components with a high degree of toughness is used for the production of rolling elements and/or rolling bearing rings. It is also possible to use the method presented for the production of shafts or housing components on which rolling elements roll, or for the production of transmission bearings or for the production of wheelset bearings for railroad applications or for the production of bolts for cam follower applications.

Generally speaking, it should be noted that the aforementioned rolling bearing steel alloy selected by way of example with the designation 100CrMnSi6-4 or with the material designation 1.3520 according to DIN EN ISO 683-17 (2015 edition) in combination with an increased purity or an increased degree of purity and in combination with the method steps of the first or second alternative of the present disclosure result in an increase in the toughness of the rolling bearing component. The increase in toughness leads to a higher pitting resistance or to a higher rolling strength and thus to an increase in the service life of the rolling bearing components, for example for the use of the aforementioned rolling bearing steel alloy in combination with the method steps of the first or second alternatives of the method for rolling bearings, such as spherical roller bearings.

1. A method for producing rolling bearing components with a high degree of toughness, comprising:
providing at least one rolling bearing component made of a steel material, wherein the steel material has a degree of purity such that in a microscopic examination of special steels for non-metallic inclusions in accordance with DIN 50602 (1998 edition) on average less than 100 non-metallic inclusions occur per 1000 mm2 of the polished surface, and wherein the steel material comprises 0.70-1.1% by weight of carbon and a mixture of alloying elements of more than 1.75% by weight and less than 3.4% by weight, wherein the mixture of alloying elements comprises manganese, chromium and silicon,
austenitizing the at least one rolling bearing component in a temperature range such that austenite and carbides are present side by side in the microstructure of the steel material, quenching the at least one rolling bearing component to a temperature which is 10 to 20 K below a martensite start temperature of the steel material, by transferring the rolling bearing component to a warm bath at a temperature in the range of 170 to 220° C. and holding it there for 14 to 25 min, whereby martensite is formed and untransformed retained austenite is maintained, and wherein carbon migrates from the formed martensite into the untransformed retained austenite,
cooling the at least one rolling bearing component to room temperature after quenching,
tempering the at least one rolling bearing component after cooling, wherein the rolling bearing component is heated to a temperature in the range of 220 to 245° C. and held at this temperature for a period of 1 to 4 hours, wherein a martensitic matrix with a retained austenite content in the range of 15% and 25% by volume is obtained as the material structure, and
subsequently cooling the rolling bearing component to room temperature, forming the rolling bearing component with a high degree of toughness.

2. A method for producing rolling bearing components with a high degree of toughness, comprising:
providing at least one rolling bearing component made of a steel material, wherein the steel material has a degree of purity such that in a microscopic examination of special steels for non-metallic inclusions in accordance with DIN 50602 (1998 edition) on average less than 100 non-metallic inclusions occur per 1000 mm2 of the polished surface, and wherein the steel material comprises 0.70-1.1% by weight of carbon and a mixture of alloying elements of more than 1.75% by weight and less than 3.4% by weight, wherein the mixture of alloying elements comprises manganese, chromium and silicon,
austenitizing the at least one rolling bearing component in a temperature range such that austenite and carbides are present side by side in the microstructure of the steel material,
quenching the at least one rolling bearing component to a temperature which is 10 to 20 K below a martensite start temperature of the steel material, by transferring the rolling bearing component to a warm bath at a temperature in the range of 170 to 220° C. and holding it there for 14 to 25 min, whereby martensite is formed and untransformed retained austenite is maintained,
heating the at least one rolling bearing component after quenching to a temperature above the martensite start temperature of the steel material used, by transferring the rolling bearing component to a warm bath at a temperature in the range of 220 to 240° C. and holding it there for a period in the range of 3 to 24 hours,
transferring the at least one rolling bearing component over a holding period in the range of 0.5 to 10 hours to a low-temperature oven or a further warm bath in which the temperature is increasing or higher compared to the warm bath, in particular in the range of 220 to 280° C., wherein bainite is formed and untransformed retained austenite is maintained, and wherein carbon migrates from the formed bainite into the untransformed retained austenite, wherein a bainitic matrix with a retained austenite content in the range of 2% and 18% by volume is obtained as the material structure, and
subsequently cooling the rolling bearing component to room temperature, forming the rolling bearing component with a high degree of toughness.

3. The method according to claim 2, wherein a bainitic matrix containing carbides and having a retained austenite content in the range of 2% and 18% by volume is obtained as the material structure.

4. The method according to claim 1,
wherein the steel material of the at least one rolling bearing component comprises 0.7-1.05% by weight of carbon and the mixture of alloying elements of more than 2.95% by weight.

5. The method according to claim 4,
wherein the steel material comprises the mixture of alloying elements of more than 3.05% by weight.

6. The method according to claim 1,
wherein the steel material of the at least one rolling bearing component comprises the following constituents:
7-1.05% by weight of carbon,
0.50-0.90% by weight or 0.40-0.75% by weight of silicon,
0.90-1.30% by weight or 0.80-1.70% by weight of manganese,
1.3-1.75% by weight or 0.90-2.05% by weight of chromium, and
residual iron and unavoidable impurities.

7. The method according to claim 1,
wherein the steel material of the at least one rolling bearing component contains a rolling bearing steel alloy,
wherein the rolling bearing steel alloy is selected from DIN EN ISO 683-17 (2015 edition).

8. The method according to claim 7,
wherein either the rolling bearing steel alloy is the alloy with the designation 100CrMnSi4-4 or with the material designation 1.3518,
or wherein the rolling bearing steel alloy is the alloy with the designation 100CrMnSi6-6 or with the material designation 1.3519,
or wherein the rolling bearing steel alloy is the alloy with the designation 100CrMnSi6-4 or with the material designation 1.3520,
or wherein the rolling bearing steel alloy is the alloy with the designation 100CrMnMoSi8-4-6 or with the material designation 1.3539.

9. A use of the method for producing rolling bearing components with a high degree of toughness according to claim 1:
for the production of rolling elements or rolling bearing rings,
or for the production of shafts or housing components on which rolling elements roll,
or for the production of transmission bearings,
or for the production of wheelset bearings for railroad applications,
or for the production of bolts for cam follower applications.

10. A rolling bearing component of a rolling bearing produced by a method according to claim 1.

11. The method according to claim 6,
wherein the steel material of the at least one rolling bearing component contains at most 0.10% by weight or at most 0.15% by weight or between 0.50% by weight and 0.6% by weight of molybdenum.

12. The method according to claim 2,
wherein the steel material of the at least one rolling bearing component comprises 0.7-1.05% by weight of carbon and the mixture of alloying elements of more than 2.95% by weight.

13. The method according to claim 12,
wherein the steel material comprises the mixture of alloying elements of more than 3.05% by weight.

14. The method according to claim 2,
wherein the steel material of the at least one rolling bearing component comprises the following constituents:
7-1.05% by weight of carbon,
0.50-0.90% by weight or 0.40-0.75% by weight of silicon,
0.90-1.30% by weight or 0.80-1.70% by weight of manganese,
3-1.75% by weight or 0.90-2.05% by weight of chromium, and
residual iron and unavoidable impurities.

15. The method according to claim 14,
wherein the steel material of the at least one rolling bearing component contains at most 0.10% by weight or at most 0.15% by weight or between 0.50% by weight and 0.6% by weight of molybdenum.

16. The method according to claim 2,
wherein the steel material of the at least one rolling bearing component contains a rolling bearing steel alloy,
wherein the rolling bearing steel alloy is selected from DIN EN ISO 683-17 (2015 edition).

17. The method according to claim 16,
wherein either the rolling bearing steel alloy is the alloy with the designation 100CrMnSi4-4 or with the material designation 1.3518,
or wherein the rolling bearing steel alloy is the alloy with the designation 100CrMnSi6-6 or with the material designation 1.3519,
or wherein the rolling bearing steel alloy is the alloy with the designation 100CrMnSi6-4 or with the material designation 1.3520,
or wherein the rolling bearing steel alloy is the alloy with the designation 100CrMnMoSi8-4-6 or with the material designation 1.3539.

18. A use of the method for producing rolling bearing components with a high degree of toughness according to claim 2:
for the production of rolling elements or rolling bearing rings,
or for the production of shafts or housing components on which rolling elements roll,
or for the production of transmission bearings,
or for the production of wheelset bearings for railroad applications,
or for the production of bolts for cam follower applications.

19. A rolling bearing component of a rolling bearing produced by a method according to claim 2.
